(19) United States
(12) Patent Application Publication
(10) Pub. No.: US 2016/0001354 A1
(43) Pub. Date: Jan. 7, 2016

(54) GAS TURBINE ENGINE COMPONENT MANUFACTURING METHOD AND CORE FOR MAKING SAME

(71) Applicant: UNITED TECHNOLOGIES CORPORATION, Hartford, CT (US)

(72) Inventors: Hector M. Pinero, Middleton, CT (US); Richard H. Page, Guilford, CT (US)

(21) Appl. No.: 14/767,612

(22) PCT Filed: Feb. 12, 2014
(86) PCT No.: PCT/US2014/016062

§ 371 Date: Aug. 13, 2015

Related U.S. Application Data
(60) Provisional application No. 61/771,185, filed on Mar. 1, 2013.

(51) Int. Cl. B22C 9/24; B22C 9/10; F01D 5/18; B22D 21/02; B22D 25/02; F01D 9/04; B22C 9/04; B22C 9/12

(52) U.S. Cl. CPC B22C 9/24; B22C 9/04; B22C 9/10; B22C 9/12; B22D 21/025; B22D 25/02; F01D 9/041; F01D 5/18; F05D 2220/32; F05D 2240/12; F05D 2240/30; F05D 2230/211; F05D 2300/177; F05D 2300/20

(57) ABSTRACT

A method of manufacturing a gas turbine engine component includes providing a core having a brittle feature, supporting the feature with a first meltable material, arranging the core with the first meltable material in a first mold, and surrounding the core and the first meltable material with a second meltable material to provide a component shape. The method also includes coating the second meltable material with a refractory material to produce a second mold, removing the first and second meltable material, and casting a component in the second mold.

### BACKGROUND

This disclosure relates to a gas turbine engine airfoil, for example. More particularly, the disclosure relates to a method of manufacturing a component with a thin ceramic core feature.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

Many blades and vanes, blade outer air seals, turbine platforms, and other components include internal cooling passages. Typically the internal cooling passages are formed using ceramic cores and/or refractory metal cores. Ceramic cores become increasingly fragile as the thickness and width decrease. As a result, thin cooling passage features cannot be formed using ceramic cores. Instead, a refractory metal core, which includes molybdenum for example, is glued into a slot in a thicker ceramic core to provide, for example, an airfoil trailing edge cooling passage. Using multiple core materials can be relatively expensive.

### SUMMARY

In one exemplary embodiment, a method of manufacturing a gas turbine engine component includes providing a core having a brittle feature, supporting the feature with a first meltable material, arranging the core with the first meltable material in a first mold, and surrounding the core and the first meltable material with a second meltable material to provide a component shape. The method also includes coating the second meltable material with a refractory material to produce a second mold, removing the first and second meltable material, and casting a component in the second mold.

In a further embodiment of the above, the core and feature are constructed from ceramic.

In a further embodiment of any of the above, the feature has a thickness of less than 0.013 inch and a width of greater than 0.100 inch.

In a further embodiment of any of the above, the core is an airfoil trailing edge core.

In a further embodiment of any of the above, the trailing edge core has a thickness of less than 0.013 inch and a width of greater than 0.100 inch. The core includes an integral adjacent core structure that has a thickness of greater than 0.013 inch.

In a further embodiment of any of the above, the airfoil trailing edge core has multiple holes. The supporting step includes having the first meltable material extend through the holes.

In a further embodiment of any of the above, the supporting step includes having the first meltable material adjoin the adjacent core structure.

In a further embodiment of any of the above, the arranging step includes assembling multiple core structures relative to one another within the mold. The core structures are configured to provide cooling passages in an airfoil.

In a further embodiment of any of the above, the first and second meltable materials are wax.

In a further embodiment of any of the above, the supporting step includes dipping the feature in molten wax.

In a further embodiment of any of the above, the surrounding step includes injecting molten wax into the first mold.

In a further embodiment of any of the above, the coating step includes dipping the second meltable material in ceramic slurry, and providing the second mold with a hardened ceramic exterior.

In a further embodiment of any of the above, the casting step includes pouring molten metal into the second mold.

In a further embodiment of any of the above, the molten metal is a nickel alloy.

In a further embodiment of any of the above, the component is one of a blade and a vane.

In a further embodiment of any of the above, the method of manufacturing a gas turbine engine component includes the step of removing the core and the second mold from the component.

In another exemplary embodiment, a core for a gas turbine engine component includes a ceramic core structure with a feature extending from the core structure. The feature has a thickness of less than 0.013 inch and a width of greater than 0.100 inch. A first meltable material coats the feature and adjoins the core structure.

In a further embodiment of any of the above, a second meltable material surrounds the core structure, the feature and the first meltable material.

In a further embodiment of any of the above, the first and second meltable materials are wax.

In a further embodiment of any of the above, the feature is integral with the core structure. The feature is an airfoil trailing edge core.

In another exemplary embodiment, a method of manufacturing a gas turbine engine component core includes providing a core having a brittle feature and supporting the feature with a first meltable material.

In a further embodiment of any of the above, the core is an airfoil trailing edge core.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2A is a perspective view of the airfoil having the disclosed cooling passage.

FIG. 2B is a plan view of the airfoil illustrating directional references.

FIG. 3 is a cross-sectional view of the airfoil taken along line 3-3 in FIG. 2A.

FIG. 4 is an enlarged view of a ceramic core structure including a support for a brittle ceramic feature.

FIG. 5 is a flow chart depicting an example method of manufacturing a gas turbine engine component, such as an airfoil.

### DETAILED DESCRIPTION

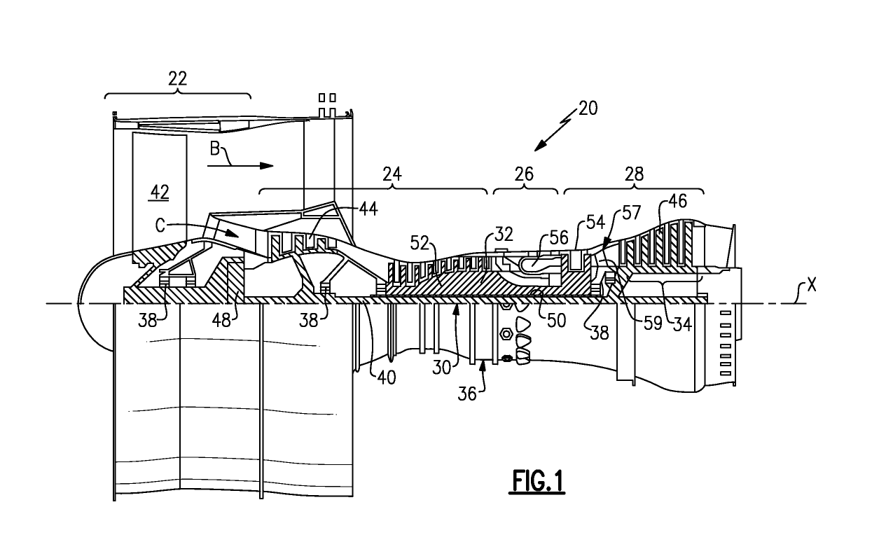

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis X.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about five (5). The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R)]^{0.5}. The “Low corrected fan tip speed”, as disclosed herein according to one non-limiting embodiment, is less than about 1150 ft/second.

The disclosed cooling passage may be used in various gas turbine engine components. For exemplary purposes, a turbine blade 64 is described. It should be understood that the cooling passage may also be used in vanes, blade outer air seals, and turbine platforms, for example.

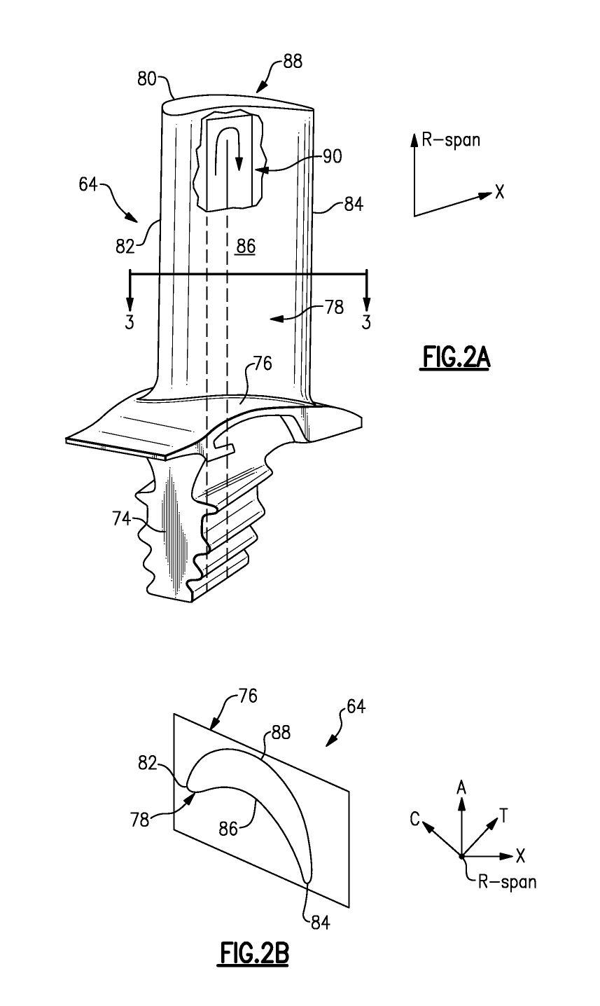

Referring to FIGS. 2A and 2B, a root 74 of each turbine blade 64 is mounted to the rotor disk. The turbine blade 64 includes a platform 76, which provides the inner flow path, supported by the root 74. An airfoil 78 extends in a radial direction R from the platform 76 to a tip 80. It should be understood that the turbine blades may be integrally formed with the rotor such that the roots are eliminated. In such a configuration, the platform is provided by the outer diameter of the rotor. The airfoil 78 provides leading and trailing edges 82, 84. The tip 80 is arranged adjacent to a blade outer air seal (not shown).

The airfoil 78 of FIG. 2B somewhat schematically illustrates exterior airfoil surface extending in a chord-wise direction C from a leading edge 82 to a trailing edge 84. The airfoil 78 is provided between pressure (substantially concave) and suction (substantially convex) wall 86, 88 in an airfoil thickness direction T, which is generally perpendicular to the chord-wise direction C. Multiple turbine blades 64 are arranged circumferentially in a circumferential direction A. The airfoil 78 extends from the platform 76 in the radial direction R, or spanwise, to the tip 80.

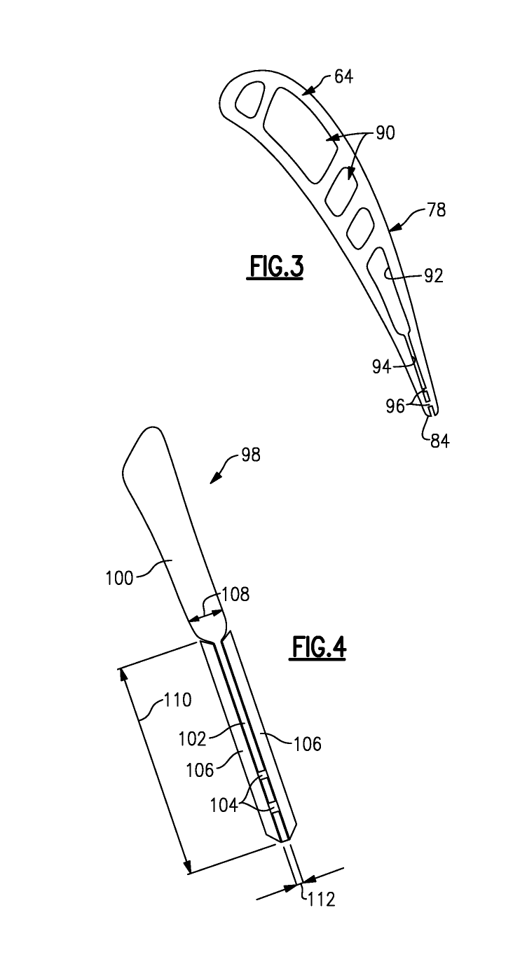

The airfoil 78 includes a cooling passage 90 provided between the pressure and suction walls 86, 88. The exterior airfoil surface may include multiple film cooling holes (not shown) in fluid communication with the cooling passage 90. The example cooling passages 90 illustrated in FIG. 2A is shown in more detail in FIG. 3.

FIG. 3 illustrates one example arrangement of cooling passages 90 in the turbine blade 64. One of the cooling passages 90 includes a trailing edge main passage 92 that communicates with a relatively thin trailing edge cooling passage 94 that extends to the trailing edge 84. The trailing edge cooling passage 94 may include pins 96 that extend laterally between the pressure and suction side walls and promote turbulence.

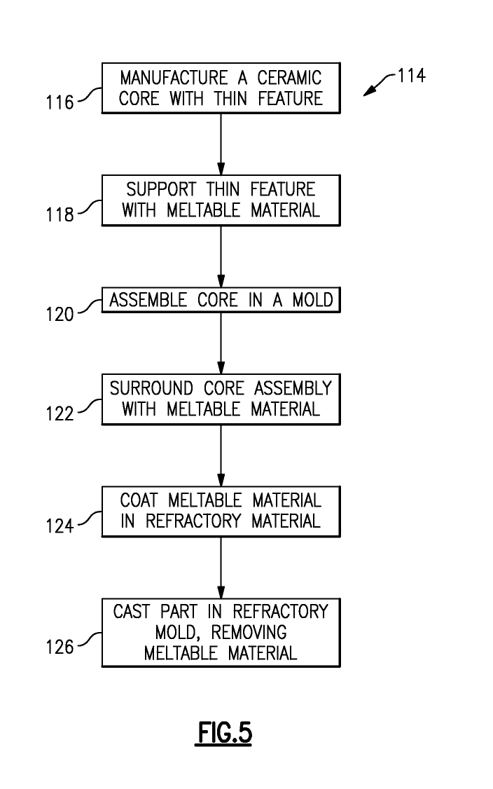

The trailing edge cooling passages 92, 94 are provided by a ceramic core structure 98, shown in FIG. 4. The ceramic core structure 98 includes a main core structure 100 from which a trailing edge core 102 is integral with and extends from. The trailing edge core 102 includes holes 104, which form the pins 96 during the casting process. Since the ceramic core structure 98 is constructed from a brittle material, the trailing edge core 102 is susceptible to breaking away from the core 100 during handling and casting. In the example, the trailing edge core 102 has a width 110 greater than 0.100 in (2.54 mm) and a thickness 112 of less than 0.013 in (0.33 mm) The main core structure 100 includes a thickness 108 of greater than 0.013 in (0.33 mm).

A support 106 is arranged on either side of the trailing edge core 102. The support 106 adjoins the core 100 to support the trailing edge core 102 relative to the main core structure 100 to resist breakage. In one example, the support 106 is provided by a meltable material such as wax or a water-soluble material.

Referring to FIG. 5, a method 114 of manufacturing a gas turbine engine component, such as an airfoil, is depicted in the flow chart. A ceramic core is manufactured having a brittle feature, for example a thickness of less than 0.013 in (0.33 mm) and a width of greater than 0.10 in (2.54 mm), as schematically indicated at block 116. The feature, which may be a trailing edge core 102, is supported with a first meltable material, such as wax or a water-soluble material, as indicated at block 118. The feature may be dipped into a molten wax to provide the support 106, which extends through the holes 104 of the trailing edge core 102. The core structure 98 along with any other cores may be assembled into a mold, as indicated at block 120. The mold provides an exterior shape of a component, such as a turbine blade, and the cores provide the shape of the internal cooling passages 90.

The cores and support 106 are surrounded by a second meltable material, as indicated at block 122. In one example, the first mold is injected with molten wax, which is solidified to provide a component shape. The solidified wax is removed from the first mold and coated in a refractory material, such as ceramic slurry, as indicated at block 124. Once the ceramic slurry has solidified, the first and second meltable materials are removed. Molten metal may be poured into the second mold provided by the hardened ceramic, to provide the cast component, as indicated at block 126. In the example of a turbine blade, the blade is cast from a nickel alloy. The hardened ceramic is broken away from the cast component, and the cores are removed by a chemical leaching process, for example.

Although example embodiments have been disclosed, a worker of ordinary skill in this art would recognize that certain modifications would come within the scope of the claims. For that and other reasons, the following claims should be studied to determine their true scope and content.

What is claimed is:

1. A method of manufacturing a gas turbine engine component comprising:
providing a core having a brittle feature;
supporting the feature with a first meltable material;
arranging the core with the first meltable material in a first mold;
surrounding the core and the first meltable material with a second meltable material to provide a component shape;
coating the second meltable material with a refractory material to produce a second mold; removing the first and second meltable material; and
casting a component in the second mold.

2. The method according to claim 1, wherein the core and feature are constructed from ceramic.

3. The method according to claim 2, wherein the feature has a thickness of less than 0.013 inch and a width of greater than 0.100 inch.

4. The method according to claim 1, wherein the core is an airfoil trailing edge core.

5. The method according to claim 4, wherein the trailing edge core has a thickness of less than 0.013 inch and a width of greater than 0.100 inch, and the core includes an integral adjacent core structure that has a thickness of greater than 0.013 inch.

6. The method according to claim 5, wherein the airfoil trailing edge core has multiple holes, and the supporting step includes having the first meltable material extend through the holes.

7. The method according to claim 5, wherein the supporting step includes having the first meltable material adjoin the adjacent core structure.

8. The method according to claim 1, wherein the arranging step includes assembling multiple core structures relative to one another within the mold, the core structures configured to provide cooling passages in an airfoil.

9. The method according to claim 1, wherein the first and second meltable materials are wax.

10. The method according to claim 1, wherein the supporting step includes dipping the feature in molten wax.

11. The method according to claim 1, wherein the surrounding step includes injecting molten wax into the first mold.

12. The method according to claim 1, wherein the coating step includes dipping the second meltable material in a ceramic slurry, and providing the second mold with a hardened ceramic exterior.

13. The method according to claim 1, wherein casting step includes pouring molten metal into the second mold.

14. The method according to claim 13, wherein the molten metal is a nickel alloy.

15. The method according to claim 14, wherein the component is one of a blade and a vane.

16. The method according to claim 1, comprising the step of removing the core and the second mold from the component.

17. A core for a gas turbine engine component comprising:
a ceramic core structure;
a feature extending from the core structure, the feature has a thickness of less than 0.013 inch and a width of greater than 0.100 inch; and
a first meltable material coating the feature and adjoining the core structure.

18. The core according to claim 17, wherein a second meltable material surrounds the core structure, the feature and the first meltable material.

19. The core according to claim 18, wherein the first and second meltable materials are wax.

20. The core according to claim 17, wherein the feature is integral with the core structure, and the feature is an airfoil trailing edge core.

21. A method of manufacturing a gas turbine engine component core, comprising:
providing a core having a brittle feature; and
supporting the feature with a first meltable material.

22. The method according to claim 21, wherein the core is an airfoil trailing edge core.
